(19) United States
(12) Patent Application Publication
(10) Pub. No.: US 2004/0010350 A1
(43) Pub. Date: Jan. 15, 2004

(54) Distributed power generation system protection scheme

(76) Inventors: Per-Anders Lof, Somerville, MA (US); Lars Gertmar, Vasteras (SE); Daniel Karlsson, Malmo (SE)

Correspondence Address: DYKEMA GOSSETT PLLC, 1300 I STREET N.W., WASHINGTON, DC, 20005, US

(21) Appl. No.: 10/446,155

(22) Filed: May 28, 2003

Related U.S. Application Data
(63) Continuation-in-part of application No. 09/653,544, filed on Aug. 31, 2000, now abandoned.

(30) Foreign Application Priority Data
May 31, 2000 (SE) 0002050-3

(51) Int. Cl. G05D 3/12

(52) U.S. Cl. 700/292

(57) ABSTRACT

A distributed power generation system (100) has at least two distributed power sources (104) connected to a point of connection (150) to a power utility network by interconnections, and is provided with a system protection scheme. The system protection scheme comprises at least three system protection terminals (18). One system protection terminal (18A) is located in the vicinity of the point of connection (150), while two others (18B-E) are located in the vicinity of one power source (104) each. The system protection terminals (18) are interconnected by a communication system (22), using a substantially dedicated communication resource. The system protection terminals (18) are equipped to measure characteristics of the power system at that particular location, preferably complex ac quantities and stability indicators. The measurements are spread to other system protection terminals (18). The system protection terminals (18) in the vicinity of the power sources (104) are equipped to evaluate the local stability condition and if necessary provide control signals to nearby situated power system units.

### TECHNICAL FIELD

The present invention relates to schemes for network protection of distributed electric power generation systems, and of electric power systems employing such schemes. Network protection refers to measures in order to avoid or reduce a substantial disturbance in an electric power system.

### BACKGROUND

Control and protections in electric power systems are of many different kinds. Single units are often provided with protection devices, which may detect any faults or if the unit is operated outside its limits. Such a protection device typically reduces the operation conditions or disconnects the unit, and is therefore only concerned about the local conditions.

In the present disclosure, “power system”, “power network” and similar terms refers solely to electric power, even if not explicitly mentioned.

In traditional power networks, large generation facilities, such as fossil fuel power plants, hydroelectric plants and nuclear plants) produce electric power to be distributed by a utility network. The power of such a generation facility is typically large, normally ranging from a few hundred kW to several hundred MW. The operation of such a plant is today generally rather reliable and the connection of active power from such plants to the utility grid is well known and controlled. The plants and their protectional systems are designed to easily ride through at least minor and medium disturbances. Such disturbances can have their origin within the generation plant or in the utility network.

In addition to such large-power generation facilities, also smaller power-generation plants are present, such as photovoltaic power generators, wind power generators etc. They typically produce powers from a few kW to a few MW. If such facilities are connected to the utility grid, they also need some protectional systems to guarantee a problem-free operation. Such systems are, however, typically expensive in relation to the generated power.

A general trend today is to collect a number of small power generators into groups or farms of distributed power generators. A typical example is wind power generators. Wind power generators comprise traditional single turbines close to scattered houses as well as large farms, both are normally in areas where there is normally a weak electrical infrastructure because windy places are avoided as settlements for mankind as well as for most production facilities. Off-shore and near-coastal sites are examples as well as farms in deserts. It will in such a case be advantageous to use one common point of connection to the utility grid. From the utility grid side, the distributed power generators are together seen as one large power plant, and protection schemes according to prior art are applied.

The term “distributed generators” is in the present disclosure used to describe a set of interconnected generators contributing to a common power output. The generators are typically spread over a certain limited area.

However, despite the resemblance with traditional large-power generator plants, the distributed power generator system has a completely different response on disturbances. Since the actual power generation of the different generators is independent of each other, many parts may be influenced in a similar manner by a disturbance. In a state-of-the-art system, the typical response to a disturbance is to disconnect a number of distributed generators to ensure the stability of the major electrical power system. When such stability is achieved, the disconnected distributed power generators are re-connected to the system in a controlled manner. The result of such a protection procedures is that a large part of the active power is initially removed and re-appears slowly again. The disconnection takes typically place within fractions of a second, while the re-connection takes a number of seconds or even longer times.

Having a large-power generation plant of distributed generators, such behavior will be difficult to handle by the utility grid. A sudden loss of several MW and the re-establishment of the power generation within a short time will cause large secondary disturbances in the electrical power system. If the original disturbance occurred outside the power generation plant, these secondary effects will even deteriorate the already strained conditions.

For system disturbances, where the whole or substantial parts of a general electric power system are involved, system protection schemes are used, which detects the occurrence or an acute risk for occurrence of a major disturbance and provides measures to reduce the consequences. Such measures may e.g. be the disconnection of certain loads, the division of the power system network into smaller autonomously operating networks, etc. The situation, in which these system protection schemes are activated, are emergency or close to emergency situation, and the time for performing the necessary actions is very limited, typically in the order of a part of a second up to half a minute.

In many countries there is an on-going restructuring of the electric power industry. This restructuring includes deregulation, and in some cases privatization, of electric utilities. These changes in power markets around the world have led to substantially reduced investments in infrastructure, i.e. investments in hardware. A continuously increasing load level in combination with new power flow directions has led to that new operation conditions may appear for the system operators with respect to earlier operation conditions in well known electric power systems. New operation situations and fast production changes and power flow changes associated therewith increases the demands on operator's tools and facilities to have a continuous overview and automated/manual control of the operation security and margins in the electric power system. The demands for models, measurement data and calculation programs will thereby increase.

One of the causes for the at present, in many places, increasing interest in stability issues is that a load growth without a corresponding increase in transmission capacity has resulted in that many power systems today are being operated closer to their limits. During the last decades, there has been an increase in generation capacity as well as in use of electricity in the industrial world. A problem is the power delivery infrastructure, which is becoming more stressed in the new high-traffic and more competitive electricity industry. The power grids have over the years also become more widely interconnected and cover larger geographical areas. The power grids built and extended during past decades were, in many cases, not planned for handling the large number of transactions taking place in today's deregulated power markets. As a result, there is likely a substantially increased risk for larger scale power system failures (blackouts). The use of distributed power generation systems without proper internal disturbance protection further increase such problems.

The dependence in modern society on a reliable power supply must not be underestimated. Furthermore, more and more customers are today more and more sensitive to disturbances in the electric power systems. The increased focus on power quality (PQ) issues includes both unwanted variations in the power supply in form of e.g. voltage sags and dips as well as disruptions in the supply of power. For this reason, some of the existing defense plans have to evolve from systems designed in the 1960s or 1970s to meet the requirements of the actual power systems today. It is further from a design viewpoint not possible to build a power system that can withstand all contingencies that may occur. In such a view, electric power systems with a large amount of relatively unstable distributed power generation sources are problematic.

In case of serious faults, combination of faults or extreme load or unexpected production changes in the power system, there are network protections at a number of locations over the world, which try to avoid extensive network breakdowns and instead limit the consequences and facilitate the recover of the network. The area of system protection schemes (SPS) comprises a number of different types of systems, where the information carrying signals may be control signals as well as information that certain measurement values have exceeded or fallen below their limits.

The defense plans of today against serious disturbances are mainly adapted for transient phenomena in the power network, appearing in the shape of frequency discrepancies as a result of active power imbalance. These types of system protection schemes are mainly concerned with load disconnection, but there are also plans comprising islanding of the network according to predetermined sections between the areas in case of extreme operation conditions. This type of protection scheme, partitioning the power system into smaller areas, and thereby having a better opportunity to maintain the operation, is installed in a few places in northwestern USA, France and Belgium.

The French system is described in the article “Major Incidents on the French Electric System: Potentiality and Curative Measurement” by C. Counan et. al., IEEE Transactions on Power Systems, Vol. 8, No 3, August 1993, pp. 879-886. The system is built up in a hierarchic structure, where detection devices are scattered over the network according to a certain configuration. The detection devices are connected to a central analyzing unit, determining the risk for disturbances. The detection devices detect voltage beats by monitoring the variations of local voltage. In case of disturbances, the network is fragmented upon request of the central analyzing unit into isolated islands, having one or several detection devices.

The French defense scheme is also presented in the research report “Contingencies System against Loss of Synchronism Based on Phase Angle Measurements” by M. Bidet, Electricité de France (EdF) Report 93NR00009, Direction des Etudes et Recherches, March 1993. The defense scheme is presented as a last line of defense for countering cases of loss of synchronism, only to be activated in case other protection systems fail to eliminate the disturbance. The system is based on synchronized phase angle measurements sent to a central point in the network, which dispatches e.g. line tripping or load shedding commands if a case of loss of synchronism is detected. The centralized structure is considered as a main characteristic of the proposed defense plan.

In existing system protection schemes of general electric networks, the measured quantities often are insufficient to efficiently detect disturbances of the kind emerging from and within large distributed power generation plants. More detailed knowledge about the conditions in different parts of the allover power system is requested to achieve a more complete picture of the situation.

A network protection system in southern Sweden against voltage collapse has been designed jointly by Svenska Kraftnät, Vattenfall A B and Sydkraft A B and is described in e.g. “Special Protection Scheme against Voltage Collapse in the South Part of the Swedish Grid”, by B. Ingelsson et. al., CIGRÉ Paper 38-105, Paris, August 1996 or “Wide-Area Protection Against Voltage Collapse” by B. Ingelsson et. al., IEEE Computer Applications in Power, Vol. 10, No 4, October 1997, pp. 30-35. The objective of the network protection system is to avoid a voltage collapse after a severe fault in a stressed operation situation. The system can be used to increase the power transfer limits from the northern part of Sweden or to increase the system security or a mixture of both.

A number of indicators such as low voltage level, high reactive current composants from power generation stations and their generator current limiters hitting limits are used as inputs to a logical decision-making process implemented in the Sydkraft SCADA (Supervisory Control And Data Acquisition) system. Local actions are then ordered from the SCADA system, such as switching of shunt reactors and shunt capacitors, start of gas turbines, request for emergency power from neighboring areas, disconnection of low priority load and, finally, (non-discriminative) load shedding.

The network protection system is designed to have a high level of security, especially for the (non-discriminative) load shedding, as well as a high dependability. Therefore a number of indicators are used to derive the criteria for each action. The logical system is designed in such a way that a faulty indicator neither causes an unwanted operation nor causes a missed operation by the network protection system.

A severe disadvantage of the above system is that the response times turned out to be too long and undetermined. Since the ordinary SCADA communication system was used, the data treatment and the transfer times of information and control signals were in fact dependent on the general load of the SCADA system. The SCADA system is, unfortunately, typically particularly heavily loaded at stressed situations. Furthermore, the indicators were for some applications not sufficient to give a good decision support, at least with the simple logics used.

Equipment for measurement of complex ac quantities (amplitude and phase, phasor measurements) and systems for evaluating the risk for instability, based on local measurement quantities have recently been made available Measurement and collection of time stamped complex quantities, phasor quantities, with respect to current and voltage can be performed by means of a Phasor Measurement Unit (PM U). These units comprise a very accurate time reference, achievable e.g. by using the Global Positioning Satellite (GPS) system. Such systems are installed e.g. in northwestern USA to record conditions of power systems and are used for a post-evaluation of an emergency situation. See e.g. “Wide Area Measurements of Power System Dynamics—The North American WAMS Project and its Applicability to the Nordic Countries” Elforsk Report 99:50, O. Samuelsson, Technical University of Lund, January 2000.

In U.S. Pat. No. 6,496,342, a distributed monitoring system for protection of distributed power networks is disclosed. The power networks involves a power flow from a high-voltage level to several low-voltage loads. Distributed measuring units are communicating values of electrical parameters to a control unit over a high-speed communication network. The control unit includes a processor that processes the incoming data and executes fault detection and isolation measures. The control unit is typically a central unit, but can be divided into separate units for the sake of redundancy or computational capacity need. The control unit sends typically out control signals for operating e.g. different breakers within the system.

When trying to apply a general system protection scheme to a distributed power generation system, the responses are typically much too slow, In most systems, response times between detection/measurement and action is in the order of seconds. Furthermore, since each power source in the distributed power generation system in principle operates independently of each other, the number of measurements needed for the protection decisions is very large. In e.g. U.S. Pat. No. 6,496,342, measurements have to be communicated to the central unit(s) and control signaling has to be communicated back to operate different items distributed around the system. Such systems could probably operate similar as the prior art protection arrangements described above, where a simple disconnection of parts of the power distribution system (load shedding) is performed, but it is unlikely for a distributed power generation system to feed-in a substantial supply of active power during severe disturbances.

### SUMMARY

An object of the present invention is to provide a distributed power generation system, having enhanced capabilities of riding through fault situations. A further object of the present invention is to provide such a system, having capabilities of maintaining a high degree of the active power generation during disturbances. Yet a further object is to make use of time stamped quantities and quantities derived therefrom as a base for protection decisions. Another object of the present invention is to provide a distributed power generation system, which has an extremely fast response to indications of disturbances. The response time should preferably be independent of external factors. Yet another object is to provide a system protection scheme, which is reliable with respect to communication links.

Schemes, systems and methods according to the enclosed claims achieve the above objects. In general words, a distributed power generation system having at least two distributed power sources connected by interconnections to a point of connection to a power utility network, is provided with a system protection scheme. The system protection scheme comprises at least three system protection terminals, which are introduced at suitable locations in the distributed power generation system. One system protection terminal is located in the vicinity of the point of connection, while two others are located in the vicinity of one power source each. The system protection terminals are interconnected by a communication system, using a substantially dedicated communication resource.

The system protection terminals are equipped to collect measurement signals associated with one or more characteristics of the power system at that particular location. The measurements preferably comprise complex ac quantities and stability indicators. The signals are processed and data related to the measurements are spread on the dedicated communication resource to the other system protection terminals.

The system protection terminals in the vicinity of the power sources, and preferably also the one at the point of connection, are equipped to evaluate the condition of the local part of the distributed power generation system and if necessary provide control signals to nearby situated power system units. The evaluation is based on selected parts of the data available on the communication resource, locally available data and/or externally entered data. The locality of the system protection terminals enables an extremely fast response on abnormal conditions.

In preferred embodiments, the distributed power Generation system further comprises different types of energy converters and interconnections, preferably also provided with system protection terminals. In this way, different possibilities of system operation is enabled.

Preferably, the system protection terminals have local means for storing data. The data comprises the near history of system information as well as older measurements. The storing means are used e.g. at autonomous operation situation, i.e. in situations where the communication fails. The stored data is also preferably used to follow up stressed situations in a post-analysis. Preferably, the storing means are searchable databases.

The substantially dedicated communication resource connecting the system protection terminals is designed with a high capacity. For protection against transient angular instability, transient voltage instability, frequency instability and damping of system wide power oscillations, the requirements on the communication time is of the order of a 10-50 milliseconds for transient angular instability and transient voltage instability. For protection against longer-term voltage instability, communication times of up to seconds are normally acceptable.

Each system protection terminal has preferably access to at least two links of the communication system, providing a first degree of redundancy concerning communication failures. Further redundancy is achieved by providing at least two of the system protection terminals with at least three links to the communication system. Each system protection terminal comprises a processor and suitable means for the communication. Preferably, a local database is provided for each terminal.

Not only the measurements, but also the decisions are hereby performed on a local basis. The relevant data is collected from the communication system and the decision algorithms in each system protection terminal can be adjusted to the actual local situation, not subject to any extensive over-all analysis and long-distance communication of control signaling. The decentralized evaluation thus reduces the complexity of each algorithm. The communication is secured by providing dedicated communication resources between the system protection terminals.

Further advantages and examples are understood from the following detailed description.

### BRIEF DESCRIPTION OF THE DRAWINGS

The invention, together with further objects and advantages thereof, may best be understood by making reference to the following description taken together with the accompanying drawings, in which:

FIG. 1 is an exemplifying illustration of a general power network with an embodiment of a system protection scheme of a type similar to the one used the present invention;

FIG. 2 is an illustration of a defective bus bar fault in the power system of FIG. 1;

FIG. 3 is an exemplifying illustration of an embodiment of a distributed power generation network according to the present invention;

FIG. 4 is an illustration of the different states of operation of an electric power system;

FIG. 5 is an embodiment of a system protection scheme comprising substantially identical standardized system protection terminals;

FIG. 6 is a detailed block scheme of a system protection terminal used in the embodiment of FIG. 5; and

FIG. 7 is a flow diagram of a system protection method according to the present invention.

### DETAILED DESCRIPTION

Power system engineers often distinguish between on one hand unit or equipment protection and on the other hand system protection. One obvious requirement to enable a secure and reliable supply of electric power in a power network is to protect the individual components of a power system against damage, when a fault appears. This protection, normally referred to as equipment or unit protection, is typically designed to prevent the current resulting from a fault causing thermal damage to components. Such component protection typically aims to disconnect the faulty transmission line or equipment. A huge number of various component protection equipment and methods exist today, but despite the importance of such devices, the scope of the present invention does not comprise such component protection schemes.

In addition to the component protections, there is also a need to protect the integrity of the overall power network. The term integrity is concerned with the quality or condition of “something” being whole or undivided. In this case it is related to that all, or at least the vital or substantial, parts of a power network, in particular a distributed power generation network, are stable and in synchronous operation. This corresponds to that the state of operation (described below) of the power system being either normal or alert. This state of operation can in simplified terms be said to correspond to that the power flow (algebraic) equations are fulfilled, and there is no immediate risk of loss of synchronism in the electric power system. The aim is to prevent widespread interruptions or large variations in power supply. Secure and reliable electric supply is of crucial importance and in the light of the general technical development, the demands on the safety of the power system delivery will continue to increase. Considerable efforts are made to maintain the supply of electric power, not only during normal operating conditions, but also at abnormal operating conditions. A System Protection Scheme (SPS) is the common name used when the focus for the protection is the integrity of an overall power network.

An SPS is designed to detect abnormal system conditions and take predetermined, emergency action to preserve system integrity and provide acceptable system performance. The action is therefore only exceptionally a pure isolation of faulted elements, since such actions normally are provided by equipment protections. SPS action may instead comprise actions like changes in load, generation or system configuration. The object of these changes is to maintain system stability and keep the voltages, active and reactive power flows at acceptable levels.

The trend of today, to merge protection and control functions together in more and more integrated substation units, has to be considered when defining SPS. A scheme that controls the operation of objects in the power system as a preventive measure to cope with general or local abnormal operation conditions is basically an SPS. The major issue that distinguishes SPS from protection systems of power system elements or objects is how users conceive SPS. The implementation of SPS is not yet standardized with regular (‘off the shelf’) products in prior art.

All protection systems have to meet high requirements on reliability, which can be divided into high dependability and high security. High dependability is concerned with a low probability of not having a failure to operate and high security is concerned with a low probability of an unwanted operation. A System Protection Scheme should, naturally, have high reliability and in particular if a failure to operate or an unwanted operation might make the situation worse or if it includes (non-discriminative) load shedding.

A general power network has different states of operation, depending on the actual situation concerning faults, disturbances, load and generation requests, etc. The basics of defining System Operating States can be found in “Operating under Stress and Strain” by L. H. Fink and K. Carlsen, IEEE Spectrum, Vol. 15, No 3, March 1978, pp. 48-53. The general basic ideas are briefly discussed below in connection with the intended area of use of the present invention.

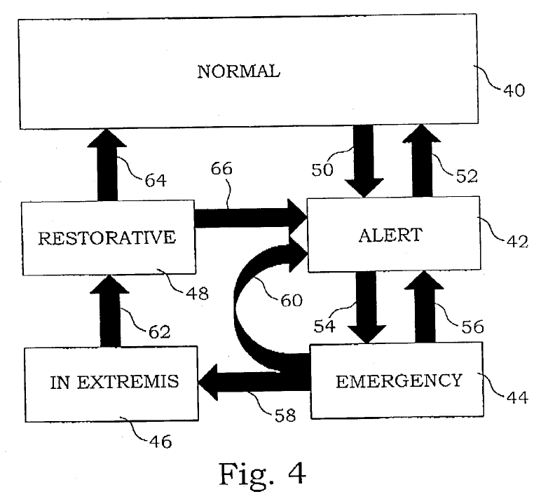

The states of operation are discussed in connection with FIG. 4, where five states of operation are illustrated. (See Appendix 1 for a more mathematical ‘definition’ for the above states of operation.) In a normal operating state 40, the power generation is adequate to supply the existing load demand. No equipment is presently overloaded. All constraints on the power system are satisfied. In this normal operating state 40, normal reserve margins are present, which margins are sufficient to provide a certain level of security. These margins are normally designed with respect to the stresses to which the system may be subjected, both regarding generation and transmission. A power system is in the normal operating state 40 during the vast majority of the time. Any deviation from this state is an exception, however, a serious one.

If conditions nevertheless are changed 50 in such a manner that the provided security level may be too small, or the probability of disturbances may have increased, the system is in an alert state 42. In this alert state 42, all constraints of the system would still be satisfied in an isolated view, i.e. no objects are operated outside its margins. However, the whole system is less secure than in the normal operating state 40. The available margins to cope with disturbances may easily be exceeded even by rather simple and common faults, which then could result in violation of some system constraints. Equipment would be more or less severely overloaded, compared with its rated capabilities. In the alert state 42, preventive actions 52 can be taken to restore the system back into the normal operating state 40. The term protecting the integrity of an overall power system can as discussed earlier in this context be related to securing the operation of the power system in the normal and, for shorter terms also, in the alert states of operation.

If such preventive actions 52 do not take place before another sufficiently severe disturbance, the system is transferred 54 into an emergency state 44. Here, system constraints are violated and the security of the system is breached since there does not exist any security level. The system is however still intact during this emergency state 44 and emergency control actions or “heroic measures” could be initiated in order to restore 56 the system to at least the alert state 42. Emergency control action should be directed towards sparing as many pieces of the system as possible and avoid a total collapse. Once a system has entered the emergency state, the deliberate control decisions and actions that are appropriate to the normal 40 and even the alert state 42 are no longer adequate. More immediate action is called for.

If the emergency control actions are too slow or inefficient, the disturbance overstresses the system. The system starts to disintegrate 58 into an “in extremis” state 46. In this state system constraints are no longer valid and major portions of the system would not be intact any more and most of the system load would be lost. If the collapse is halted 62 before all parts of the system are lost, some remaining equipment will operate within rated capability and the system will enter into a restorative state 48. Here, control actions are taken to pick up lost load and reconnect the system, even if the entire system may not be restored immediately. From this state, the system could transit 66 to the alert state 42 or go back 64 the entire way to the normal operating state 40. The actual path depends on the circumstances of the emergency situation.

The present invention mainly comes into operation in the emergency state 44. The aim of the SPS is to sense and identify situations, which normally leads to the “in extremis” state 46, take actions and bring the system back to the alert state 42. The arrow 60 in FIG. 4 thus illustrates the action of SPS. If the encountered disturbance is very severe, the transition between states of operation may take place without passing through the ‘intermediate’ stages in FIG. 4. Examples are transition directly from the normal state 40 to the emergency state 44 if the encountered disturbance is more severe than the faults described in the design criteria for the power system, and also transition directly from the alert state 42 to the “in extremis” state 46 in case of a very severe disturbance Irrespective of the precise path taken during the transition between states of operation, the general aim and purpose of an SPS is the sane.

The objective of the proposed System Protection Scheme (SPS) is consequently to avoid (serious) network disturbances, by stopping or limiting the breakdown of the system, i.e. the transition into the “in extremis” state 46 by use of so called “emergency control actions”. Today automatic load or generation shedding is the main emergency control mechanism. Performed emergency control actions are aimed at moving the state of operation from the entered emergency state 44 back into the alert state 42, and by that means avoiding transition into “in extremis” state 46, and associated power system blackouts.

The proposed System Protection Scheme focuses on system protection of distributed power generation systems and their integrity and interaction with traditional electric power systems. Emergency protection devices/schemes are dealing with incidents with a relatively low probability and enormous consequences. The risk, defined as the product of probability and consequence, for such events is therefore hard to derive. But due to the ever-increasing dependency of modern society of a reliable power supply, the proposed System Protection Scheme will serve a very important role. Strategies for reducing the risk and effects of major disturbances in the power system are a major concern for power utilities—both regarding planning and operational aspects.

A more ‘stringent’, mathematically based, definition for the states of operation presented above is given in Appendix 1.

The operation of power systems can be characterized by three objectives: quality, security and economy. The overall operational objective for power systems, and in particular for distributed power generation systems, is to find a satisfactory compromise between the two conflicting objectives of security and economy. Economic considerations are in many distributed power generation systems today, partly due to the on-going deregulation of power markets, the major influencing factor of these two objectives.

Based on the above presentation of states of operation, it follows that the intentional automatic control action that can be taken to save the distributed power generation systems or restore sufficient reserve margins, can be divided into preventive and emergency actions. During normal operation, the focus is on economic aspects of power system operation, and economic operation is hence playing the more important role. While during more stressed network operational conditions, such as in an alert state, and in particular during emergency situations, the focus for control objectives shifts towards security. The ultimate objective here is keeping as much as possible of the network intact and as many distributed generators connected to the utility grid. A total or partial breakdown normally results in one or several more severe problems in the distributed power generation systems. The main concern in the emergency state is of course system security. System Protection Schemes form in this respect a last line of defense in case of severe disturbances. The aim of actions taken by SPS is to provide uninterrupted power supply by use of sometimes rather ruthless methods, i.e. by taking actions that could be referred to as measures of last resort (and which would not be used during normal operational conditions). The objective of SPS is to retain distributed power generation system operational security.

To explain the benefits of the present invention, a couple of examples will be discussed. First, the general benefits achieved when applying concepts of the present invention to a general electric network will be illustrated, in order to get an impression of the general applicability. Secondly, the particular advantages when applied and adapted to distributed power generation systems will be discussed.

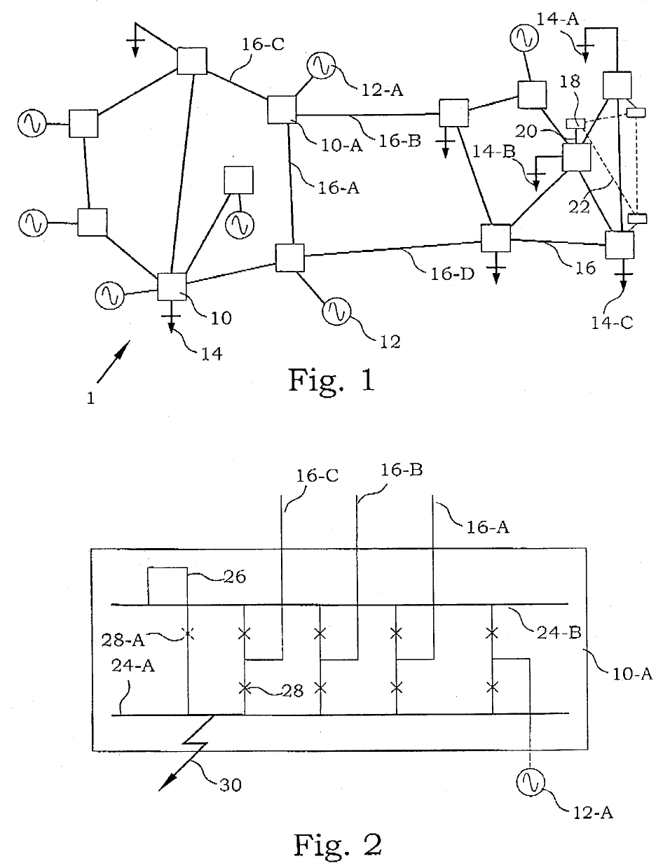

FIG. 1 illustrates a general electric power system 1 network with a system protection scheme operating according to similar basic principles as in the present invention. The general power network comprises a number of nodes 10 connected by power lines 16. (Only one of each item is provided with a reference number, unless specifically referred to.) The nodes could be connected to generators 12 and/or loads 14. System protection terminals 18 are provided at selected nodes, connected by measurement obtaining connections 20 to the nodes. A communication network 22, having at least one substantially dedicated communication resource connects the system protection terminals to each other. In this example, the nodes connected to the loads 14-A, 14-B and 14-C are provided with system protection terminals 18.

The illustrated electric power system 1 has in its left part high capacity generators 12 and in its right part many loads 14. The general transmission situation is therefore normally that the left part generates power, which is transmitted to the loads in the right part. Two main power lines connect the right and left parts of the power system.

The node 10-A in FIG. 1 is illustrated in more detail in FIG. 2. The node is an interlocking installation and bus bars 24-A, 24-B are here used for connecting the different objects 12-A and power lines 16-A, 16-B and 16-C. The power lines and objects are connected to the respective bus bars 24-A, 24-B via circuit breakers 28. A circuit breaker 28-A is also provided at the interconnection 26 between the bus bars 24-A, 24-B.

Assume a bus bar fault. The circuit breaker 28-A has become inoperable, e.g. as a result of corrosion. During normal operation, the power system will not notice this circuit breaker deficiency, and the operation continues according to normal routines. Now, assume that the lower bus bar 24-A suddenly becomes connected to ground, as illustrated by the arrow 30. The lower bus has to be disconnected immediately, which is taken care of by the typical action of object protection arrangements. Such an arrangement will open the lower circuit breakers 28 in order to separate the power lines 16-A, 16-B and 16-C and the generator 12-A from the faulted lower bus bar 24-A. Also the circuit breaker 28-A of the interconnection is ordered to open. However, due to the corrosion, this circuit breaker 28-A cannot be opened, which is why the upper bus bar 24-B also becomes connected to ground. The connections 16-A, 16-B and 16-C and the line to the generator 12-A have to be cut off, e.g. by operation of the upper circuit breakers.

Now, returning to FIG. 1, the power system 1 has lost the generator 12-A and the power lines 16-A, 16-B and 16-C. The generated power may perhaps be compensated by other generators in the power system, but all power now has to be transmitted by the single power line 16-D. The power system is subject to enter a state of voltage instability, and perhaps an overload of the 16-D line. The system equipment might however still be within permitted limits, and no further object/equipment protection is activated. Voltage stability problems can, however, within a time period of less than a minute cause a general breakdown of the electric power system 1, due to the low voltage level in the load area, load recovery, further voltage reduction, trip of overloaded equipment, and so on. A chain of events will thus lead to a breakdown.

The system protection terminals 18 according to the present invention will now come into action and save the power network. The system protection terminals are in this example provided with means for obtaining time stamped voltage values, corresponding to the respective node. These time stamped voltage values are processed to give so called complex ac quantities. These complex ac quantities are communicated by the communication network 22 in order to spread the information within the system protection arrangement. Each one of the system protection terminals 18 is in this example also provided with control signal providing means, which in turn comprises means for detecting serious risk for voltage instability. This detection means detects the risk of instability in the electric power system and provides control signals as a response to the instability risk, e.g. when two of the nodes present voltage values are below 90% of the nominal values. The control signals are sent to the respective nodes, in order to instruct a reduction of the magnitude of each of the loads 14-A, 14-B and 14-C.

In this case, line 16-D might be the critical one. To keep the integrity of the system it is very important not to trip this line. Therefore, load shedding of a fraction of the total load in the load area (preferably low priority load) might be enough to save the whole system. If no action is taken, the total of the right part of the power system, i.e. the load area, will probably experience a blackout.

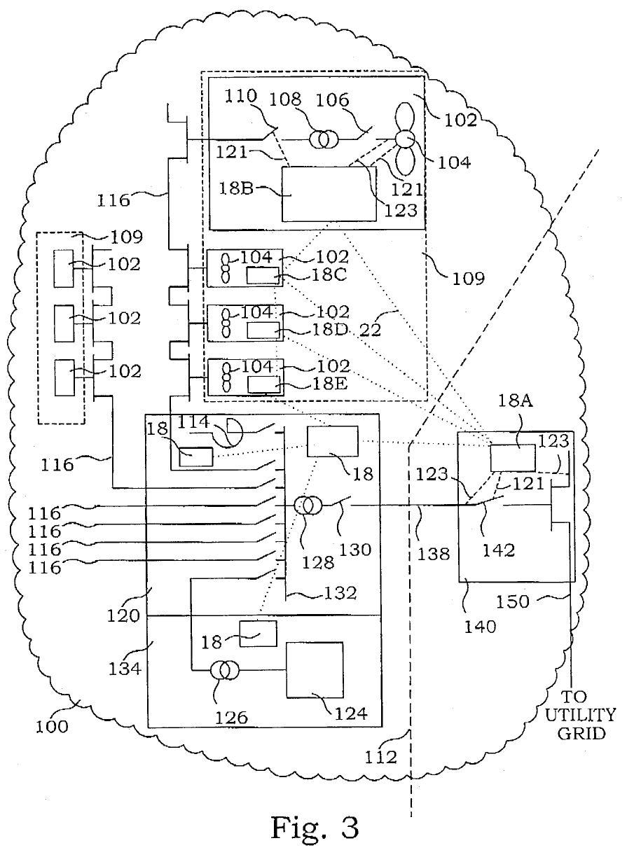

In FIG. 3, a distributed power generation system 100 is illustrated. In this embodiment, the distributed power generation system 100 is an off-shore or near-coastal site wind-power generator park. The distributed power generation system 100 comprises a number of distributed generator units 102, each of which in turn comprises a power source 104, in this embodiment a wind turbine. The distributed generator units 102 further comprises a transformer 108 and two switches 106, 110, connecting the power source 104 to the transformer 108 and the transformer 108 to a wind turbine cluster line 116, respectively. A number of distributed generator units 102 in a wind turbine cluster 109 are connected to the same wind turbine cluster line 116. A number of wind turbine clusters 109 are similarly connected to respective wind turbine cluster lines 116.

The wind turbine cluster lines 116 are connected to an off-shore transformer station 120, where the different wind turbine cluster lines 116 are interconnected by a medium-voltage switchgear 132. (In other embodiments, e.g. a near-coastal site wind-power generator park, all transformer equipment may be placed on-shore.) The off-shore transformer station 120 further comprises a main step-up transformer 128 and a circuit breaker 130. A reactor 114 is also connected to the switchgear 132 for supply of reactive power. An emergency power unit 134 comprises an emergency power source 124 and an auxilliary power transformer 126 and is also connected to the switchgear 132. A submarine cable 138 connects the off-shore transformer station 120 over a shoreline 112 to an on-shore substation 140. The on-shore substation 140 comprises a high-voltage circuit breaker 142 and a point of connection 150 to a utility grid.

A number of system protection terminals 18 are provided in the distributed power generation system 100. One system protection terminal 18A is provided in the on-shore substation 140 in the vicinity of the point of connection 150 to the utility grid. The system protection terminal 18A is arranged to measure electrical quantities by measurement connections 123 of e.g. the point of connection 150 or of the submarine cable 138. In the present embodiment, the system protection terminal 18A is further arranged to provide control signals on a control signal connection 121 to operate the high-voltage circuit breaker 142.

In the present embodiment, each distributed generator unit 102 is also provided with a system protection terminal 18B-E. These system protection terminals 18B-E are arranged to measure electrical quantities of respective distributed generator unit 102. Furthermore, the system protection terminals 18B-E are further arranged to provide control signals to power system units in the vicinity of each respective terminal. The system protection terminal 18B is for instance arranged to send control signals to the switch 106, as well as to the wind power turbine 104 itself.

If the distributed generator units 102 of the distributed power generation system 100 are localized relatively close to each other in groups, each such group may share one common system protection terminal 18. However, preferably, each individual distributed generator unit 102 is associated with its own dedicated system protection terminal 18.

The system protection terminals 18 are interconnected by a communication system 22 in analogy with the one presented in FIG. 1. Measurement values from different locations all around the distributed power generation system 100 are communicated to other system protection terminals 18 by substantially dedicated communication resources in the communication system 22. Each system protection terminal 18 extracts those measurements that are of importance for the power system units to which the system protection terminal 18 provides control signals. Based on these system measurements, a local decision on suitable emergency measures is taken. The control of corresponding power system units is then immediate, since no communication of control signals over the communication system 22 is necessary. An immediate response on detected fault situations is therefore produced locally at each system protection terminal 18 but based on system-wide measurements. The response time in such cases can be as short as 10 ms in favorable situations, which is sufficiently short for avoiding unnecessary emergency disconnecting of power sources.

A central control unit according to prior-art would obviously not be very suitable in such a system. The power collection from the wind and therefore the power generation of the individual wind turbines varies with time. This means that the operation conditions and hence control possibilities for each wind turbine vary with time. If one or a small number of control units are provided for handling the overall control of the distributed power generation system, measurement values of the present status of power generation of each individual wind turbine is necessary to be communicated to the central control unit. Most of such measurements are only relevant for control of the power system units in the vicinity of the wind turbine itself. By having any kind of centralized protection scheme, first extensive measurements have to be communicated in one direction and then corresponding control signaling in the opposite direction. This will obviously be inefficient, time consuming and resource demanding.

Assuming e.g. that there are m wind turbines in the system. m may here assume number up to hundred units or more. Each unit provides its own set of voltages and phases. In a three-phase system, each wind turbine therefore has its own set of three phases. If a central protection system would keep track on 3 times m phases and compute the most suitable measure to take, the communication and optimizing problems will be huge. By instead decentralize the decisions out to the location of the controlled power system units and typically also close to the measurement location, the need for communication of measurements as well as the need for transferring control signals will be reduced significantly.

By letting the local units make the necessary decisions, however based on system-wide information, the process requirements for each protection mode are reduced, since only relevant data are retrieved from the communication system and processed. Also, since the decisions are made closer to the actual place of the emergency action, the requirements on control signaling facilities are reduced. An advantage is also that several decision processes may be active in parallel, and there is no need for prioritizing different decision processes, as is the case for a central decision structure.

Power system units used for controlling the distributed power generation system comprise but are not restricted to distributed power generation sources, prime movers, electrical machines, VAr compensators, drive trains, power electronics, power lines, power transformers with/without voltage tap changers, fault current limiters etc.

In a typical distributed power generation system, additional equipment such as different energy converter systems and interconnections is available. Non-restricting examples could be prime movers, electrical machines, drive trains, power electronics, power lines, power transformers, fault current limiters etc. In the present embodiment a reactor 114, an off-shore transformer station 120 and an emergency power unit 134 are present. Also these units are preferably provided with system protection terminals 18. Depending on the actual unit, the system protection terminal 18 can be equipped with measuring signal obtaining and/or control signal providing means. By including control of such additional units, more diverse control possibilities are provided. In normal operation, the distributed power generation system is operated in order to provide the supply of well controlled active power through the point of connection 150, as well as of supplying reactive power and e.g. to operate tap changers for voltage control. In an emergency situation, normal reactive power supply as well as tap changer control may be abandoned in order to maintain the overall integrity of the distributed power generation system. Also the level of control of the supplied active power could be released in order to ride through an emergency situation and restore the system into a normal or at least alert state.

As opposed to prior art like in U.S. Pat. No. 6,496,342, with a distributed monitoring system for protection of distribution networks, inventive distributed power generation systems have a power flow from several low-voltage sources to high-voltage level in transmission. The protection schemes to keep integrity of a distribution network is separate from schemes needed for collection networks needed for distributed power generation systems where phasor quantities are essential as measurement quantities like stability indicators.

The communication system is one of the most important components in the present invention. It is preferred to provide a communication system which is as safe and reliable as possible. One way to provide the reliability is to provide redundancy in the communication system. Centralized protection schemes are typically based on communication systems built in a star-like or radial fashion, where the central unit communicates with the different peripheral units. For a centralized configuration, such designs are easy to implement. In the present invention, it is preferred to have an as meshed communication network as possible, at least within economical defendable frames. It is thus a desire to provide at least three of the system protection terminals with at least two communication links each. In such a way, a broken communication link may be compensated by sending the data via another path in the communication system. If all terminals are arranged in a ring structure, one broken communication link can be handled. However, a second fault will split the communication system in two parts. The more communication links available and the more meshed they are, the more alternative communication paths are present. It is thus preferred if at least two terminals have at least three communication links each.

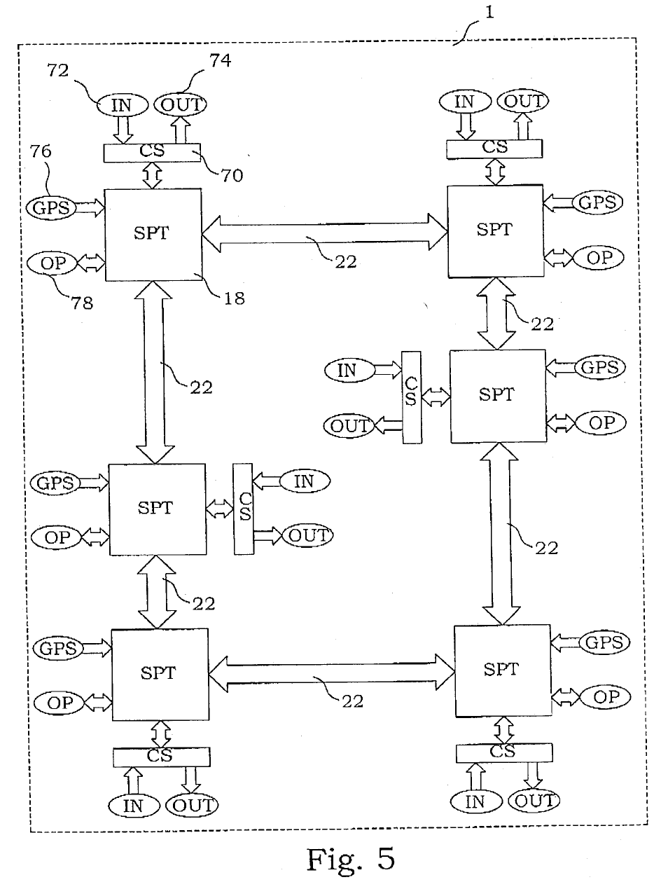

In one embodiment of the present invention, the system protection terminals are provided as more or less identical protection units, which can be connected by a communication networks to operate anywhere in a power network as parts of a system protection scheme composed of system protection terminals. One such embodiment is illustrated in FIG. 5. The system protection terminals 18 are here illustrated as exchangeable units comprising identical means and are only distinguished in the configuration of the software of each terminal. In FIG. 5, an electric power system 1 comprises six system protection terminals 18, which are interconnected by a communication network 22. Each system protection terminal 18 is connected to a control system 70 for input 72 of measured power system characteristics and for output 74 of control information to power network objects. The system protection terminals 18 of this embodiment are further equipped with a GPS interface 76 and an operator interface 78. The illustration of the communication network 22 in FIG. 5 should be regarded as a general representation of a communication network of any configuration. As mentioned above, the network may in practice be formed e.g. as a loop or a meshed structure.

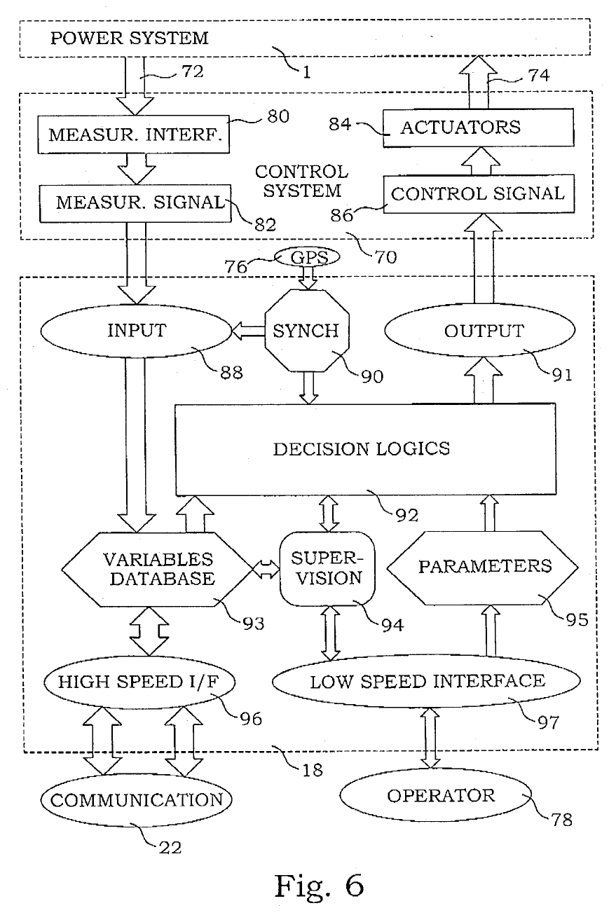

A more detailed illustration of a system protection terminal 18 according to the embodiment of FIG. 5 is shown in FIG. 6. Inputs 72 of measured power system quantities are received in the substation control system 70 by means of power system transducers and measurement devices 80. The measurement signals are transferred into internal measurement signals in a measurement signal unit 82. These local signals are communicated to an input interface 88 of the system protection terminal 18. A GPS time synchronization unit 90 uses GPS signals 76 to create a time reference for the measured data. This time reference is connected to the input interface 88 to create a time stamp for the received measurements. The time stamped measurements are further provided to a power system variable database 93. The power system variable database 93 is in turn connected bi-directionally to a high speed communication interface 96, which handles the communication on the communication network 22 to other system protection terminals 18.

The data in the power system variable database 93 will in this way contain information, not only about the power network variables of units connected directly to the system protection terminal 18 in question, but through the communication network 22 also about power network variables associated with other system protection terminals. The power system variable database 93 may therefore have, for its own purposes, a complete set of updated power system information. This information is available for a decision making logic unit 92, which is also supplied with an appropriate time reference from the GPS time synchronization unit 90. The decision making logic unit 92 is the heart of the local part of the system protection scheme. The decision making logic unit 92 interprets the available data and decides if any emergency actions have to be performed. If such actions are necessary, the decision making logic unit 92 uses an output interface 91 to send internal control signals to a control signal unit 86 in the control system 70. A power system actuator unit 84 transfers the internal control signals into relevant control signals 74 acting on the associated objects in the electric power system 1. The basic idea of this embodiment is thus that each system protection terminal 18 is responsible for measurements as well as emergency control signals to a number of objects in the power system. The decisions are made locally and may therefore more easily reach a sufficiently short reaction time during instabilities or disturbances. The design with local decisions for actions also improves the overall protection system reliability.

A supervision unit 94 for supervision, service, maintenance and updates communicates with the power system variables database 93 and the decision making logic unit 92. This supervision unit 94 monitors and evaluates the operation of the system protection terminal 18 based on the information which was available in the power system variables database 93. Preferably, the supervision unit 94 comprises or is connected to a database of historic power system state information. Such a database may be used for post-analysis of stressed situations or as a temporary source of local control information if the communication with other system protection terminals is broken. The supervision unit 94 is bi-directionally connected to a low speed communication interface 97, for enabling communication with an operator via an operator interface 78. The operator is thereby allowed to monitor and influence the operation of the system protection terminal 18. Such an interaction is intended to be used in a precautionary manner and is normally not used for the emergency situations as such. The low speed communication interface 97 is also connected to a parameter setting database 95, which in turn is readable by the decision making logic unit 92. The parameter setting database 95 comprises parameters used by the decision making logic unit 92 in its operation. The operator thus has a possibility to manually tune the decision logics during operation, i.e. without taking the SPS out of service.

In some cases, the system protection terminal 18 may be necessary for emergency control of some power system objects, but no corresponding measurements are required. The system protection terminal 18 may in such cases lack the units for measurement input, i.e. units 80, 82 and 88. The entire information on which the decision is based is in such cases received by the communication network 22 from other system protection terminals 18. The emergency control action decision is, however, made locally.

In other cases, no emergency control actions at all are relevant for the power system objects associated with the system protection terminal 18. In such cases, the system protection terminal 18 acts as an administrative system for measurement input, and decision logics and associated units may be omitted.

In a system comprising all of the variants above, some terminals only contains measurement related equipment, some terminals only contain emergency control related equipment, and some terminals contain both. In a general view, the system protection scheme comprises a set of system protection terminals. A first subset of terminals comprises means for measurement handling. This first subset may contain all terminals in the set or less. The first subset should, however, comprise at least two terminals associated with power sources and one terminal associated with the point of connection to the utility grid. A second subset of terminals comprises means for emergency control. This second subset may contain all terminals in the entire set or less. It may also be identical to the first subset, if all terminals comprise both functions, or have a number of common terminals. The second subset should by the same reasons as for the first subset comprise at least two terminals associated with power sources.

In some cases, where control actions are extremely straightforward and the probability of such actions very unlikely, the actual decision making logic unit may be considered to be unnecessary. A neighboring terminal may then effect the operation of such emergency control, by providing a connection between the output interface 91 and the high-speed communication interface 96. In a first terminal, the decision making logic unit 92 affects not only the decisions concerned with its own associated power system object, but also with power system objects associated with a neighboring terminal. If a control action on such neighbor object is determined, the internal control signal is provided to the high-speed communication interface 96 for further delivery to the neighboring terminal. In the neighboring terminal, which basically lacks the decision logics, the control signal is received in the high-speed communication interface 96 and is forwarded directly to the output interface 91. Such solutions are, however, not suitable when the time aspects are critical, since it involves additional communication steps.

Since the system protection terminal is located in the vicinity of power system units, the system protection terminal is in one embodiment integrated within other equipment associated with different power system units in order to reduce the number of device units. In another embodiment, the system protection terminal is configured as a distributed device, where the different functionality physically can be placed at different locations and/or be integrated in other devices. The expression “system protection terminal” should therefore be interpreted as a group of functionalities associated with the protection of the network integrity rather than a separate physical device, even if this also can be the case.

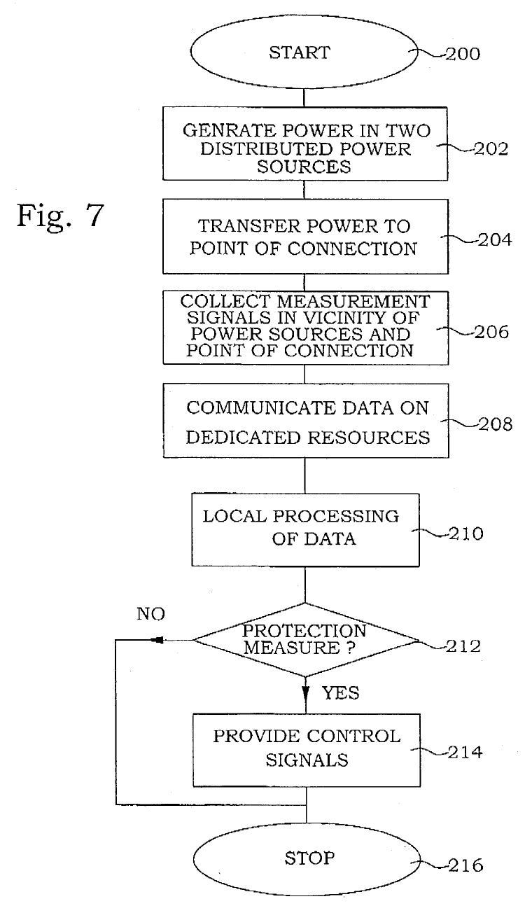

FIG. 7 shows a flow diagram of a general method for system protection according to the present invention. The process starts in step 200. In step 202, electric power is generated in at least two distributed power sources. The electric power is transferred over interconnections to a point of connection to a power utility network in step 204. In step 206, measurement signals corresponding to power system characteristics are collected in terminals located in the vicinity of the distributed power sources and the point of connection. Data associated with the measurements are communicated to the other terminals in step 208. The communication takes place via a substantially dedicated communication resource. In step 210, the terminals in the vicinity of the distributed power sources process available data for evaluating system stability and disturbance situation. In step 212, it is determined if any need for emergency system protection measures is present. If no emergency protection measures are necessary, the process continues to step 216. If emergency protection measures are necessary, the process continues to step 214, where control signals for actuating such protection measures in the vicinity of respective terminal are provided. The process ends in step 216.

The method according to the present invention may be implemented as software, hardware, or a combination thereof. A computer program product implementing the method or a part thereof comprises a software or a computer program run on a general purpose or specially adapted computer, processor or microprocessor. The software includes computer program code elements or software code portions that make the computer perform the method using at least one of the steps previously described in FIG. 7. The program may be stored in whole or part, on, or in, one or more suitable computer readable media or data storage means such as a magnetic disk, CD-ROM or DVD disk, hard disk, magneto-optical memory storage means, in RAM or volatile memory, in ROM or flash memory, as firmware, or on a data server.

Suitable primary power system quantities that can be measured and used as inputs to the system protection terminals are e.g. voltage, current, status of preferably power system high voltage equipment, status of power system control and protection equipment, such as start and trip signals, and positions or actual values for control functions. The magnitude, phase angle and frequency are the most interesting features when measuring voltages and currents. Power system high voltage equipment comprises equipment such as transformers, circuit-breakers, disconnecting switches, capacitor banks, reactors and power system control and protection equipment comprises e.g. voltage regulators, speed-governor controls, valve actuators, relays as well as HVDC and FACTS controllers. Such equipment is today to certain extent available in distributed power generation systems. Also other quantities may be used. The quantities are preferably time stamped. From time stamped measures, complex ac quantities, so called phasor quantities, are derivable. The quantities may be communicated as measured or may be pre-processed before being communicated to other terminals.

Based on these quantities a large number of related quantities can be derived, such as frequency, derivatives of the quantities, active and reactive power. Also sums, differences, maximum and minimum values are easily derivable. Also relation quantities such as thresholds, “larger than”, “smaller than”, etc., can be computed and used.

The measurements can be derived from many different transducers in the power system. Non-limiting examples are e.g. voltage transformers, current transformers, binary signals from relays, active and reactive power transducers, generator speed transducers and temperature transducers More specific transducers, such as phasor measurement units (PMUs), voltage instability predictors (VIPs) as well as transducers sensitive to frequency instability, poorly damped power oscillations and transient instabilities, can also be used.

A phasor measurement unit (PMU) provides continuous or sampled phasor measurements in real time. Synchronized phasor measurements are e.g. described in “Synchronized Phasor Measurements in Power Systems” by A. G. Phadke in IEEE Computer Applications in Power, Vol. 6, No 2, April 1993, pp. 10-15. Such equipment is commercially available from several different suppliers, e.g. PMU model 1690 from Macrodyne, Inc. This PMU unit has an effective sample rate of more than 2 kHz and is time synchronized using GSP time to an accuracy of 1 μs.

The operation of a voltage instability predictor (VIP) is e.g. described in “Grids Get Smart Protection and Control” by K. Vu et. al., IEEE Computer Application in Power, Vol. 10, No 4, October 1997, pp. 40-44. Such predictor units can be designed to operate directly on measurements and provide control signals as input signals to a system protection terminal. The VIP unit then operates only on locally obtained data and is an input device to the system protection terminal. As an alternative, the algorithms of a VIP can be used and integrated into the decision making process of the system protection terminal itself. The VIP will then constitute a part of the decision making logic unit 92 (FIG. 6).

Predictors sensitive to frequency instability, thermal violations having an impact on stability properties, poorly damped power oscillations and transient instabilities may in the same manner be utilized in the system protection scheme. They may be implemented as separate units operating only on local measurements, or may be implemented as a part of the system protection terminal decision logics.

The emergency control actions are sent as orders to objects in the power system. Suitable, but non-limiting examples could be generator governors, generator AVRs (Automatic Voltage Regulators), HVDC (High Voltage Direct Current) controllers, SVC/FACTS (Static Var Compensator/Flexible AC Transmission Systems) controllers, transformer OLTCs (On-Load Tap-Changers) and circuit breakers for e.g. load shedding, generator rejection, shunt capacitors and shunt reactors. Most conventional controllable objects may be used to perform required emergency control actions according to the decisions made by the system protection terminal.

The communication system is an important part of the present invention. Since the system protection scheme operates in the emergency state of operation of a power system, the time is an important factor. Data has to be communicated between the different system protection terminals in such a fast manner that emergency actions still may have the intended effect. Using ordinary communication systems, sharing the communication resources gives an unacceptable uncertainty of the communication speed.

The communication system of the present invention thus requires a substantially dedicated communication resource for the communication between the system protection terminals. Such dedication ensures that the transmission times within the communication network can be estimated and all data can be available at all terminals within a predetermined time. The value of this time depends on the transmission capacity of the communication resource, the amount of data to be communicated and the communication network configuration. In order to be able to establish protection against transient angular instability, transient voltage instability, frequency instability and damping of system wide power oscillations, the requirements on the predetermined maximum communication time are of the order of fractions of a second. Some ten milliseconds are needed for transient angular instability and transient voltage instability. Time limits of a second might be enough for frequency instability and damping purposes. For protection against longer-term voltage instability, communication times of up to five seconds are normally acceptable. The capacity of the communication resource has to be adapted thereafter, stressing the importance of fixed (or at least predictable) delays in the communications system.

The term “communication resource” is in this document referring to any limited, allocable communication resource. Examples could be time slots or frequency bands in radio transmitted communication systems, or even separate physical links, such as dedicated fibers or wires. The important feature is that the capacity of the resource is permanently allocated to the system protection scheme communication and not influenced by competing traffic.

The actual implementation of the communication system can according to conventional technology be performed in many different ways. Fiber networks, microwave links or for shorter distances even copper wires are possible solutions, either separately or in combination. Communication using publicly available networks, such as Internet, would also be possible, if the transmission requirements can be ensured. Communication based on power line carriers may be a well-suited alternative. However, the probability for interruptions in communication increases in connection with instability in the network.

In the above detailed embodiment, the distributed power sources were wind turbines. However, the principles of the present invention can be applied also to other distributed power generation systems. Other non-restrictive examples are photovoltaic systems and fuel cell systems as well as distributed diesel-fuelled generator equipment.

It will be understood by those skilled in the art that various modifications and changes may be made to the present invention without departure from the scope thereof, which is defined by the appended claims.

### REFERENCES

C. Counan et. al.: “Major Incidents on the French Electric System: Potentiality and Curative Measurement”, IEEE Transactions on Power Systems, Vol. 8, No 3, August 1993, pp. 879-886.

M. Bidet: “Contingencies System against Loss of Synchronism based on Phase Angle Measurements”, Electricité de France (EdF) Report 93NR00009, Direction des Etudes et Recherches, March 1993.

B. Ingelsson et. al.: “Special Protection Scheme against Voltage Collapse in the South Part of the Swedish Grid”, CIGRÉ Paper 38-105, Paris, August 1996.

B. Ingelsson et. al.: “Wide-Area Protection Against Voltage Collapse”, IEEE Computer Applications in Power, Vol. 10, No 4, October 1997, pp. 30-35.

O. Samuelsson: “Wide Area Measurements of Power System Dynamics—The North American WAMS Project and its Applicability to the Nordic Countries” Elforsk Report 99:50, Technical University of Lund, January 2000.

L. H. Fink and K. Carlsen: “Operating under Stress and Strain”, IEEE Spectrum, Vol. 15, No 3, March 1978, pp. 48-53.

A. G. Phadke: “Synchronized Phasor Measurements in Power Systems”, IEEE Computer Applications in Power, Vol. 6, No 2, April 1993, pp. 10-15.

K. Vu et. al.: “Grids Get Smart Protection and Control”, IEEE Computer Application in Power, Vol. 10, No 4, October 1997, pp. 40-44.

U.S. Pat. No. 6,496,342.

[image]

[image]

[image]

[image]

[image]

1. Distributed power generation system, comprising:
at least two distributed power sources;
point of connection to a power utility network;
interconnections between said at least two distributed power sources and said point of connection, allowing for energy transfer; and
system protection scheme for protection of the integrity of entire said distributed power generation system,
said system protection scheme in turn comprising:
system protection terminals, whereby a first system protection terminal is associated with and located in the vicinity of said point of connection, a second and a third system protection terminal is associated with and located in the vicinity of a respective one of said at least two distributed power sources; and
a communication system connecting said system protection terminals;
said first, second and third system protection terminals in turn comprising a processor unit and a communication unit connected to said processor unit for communication on said communication system,
said first, second and third system protection terminals further comprising measurement signal obtaining means connected to said processor unit for collecting measurement signals of measured characteristics of said distributed power generation system;
said communication unit being arranged for communication of data associated with said measurement signals over a substantially dedicated communication resource in said communication system; and
said first, second and third system protection terminals further comprising control signal providing means connected to said processor unit for providing control signals to power system units.

2. Distributed power generation system according to claim 1, in which power sources of said distributed power generation system are localized in groups, whereby each of said groups comprises a said system protection terminal.

3. Distributed power generation system according to claim 1, in which each power source is associated with a system protection terminal.

4. Distributed power generation system according to claim 1, wherein said characteristic of said electric power system comprises at least one of:
time stamped voltage values;
time stamped current values;
complex ac quantities, so called phasor quantities;
frequency; and
stability indicators.

5. Distributed power generation system according to claim 1, wherein at least one interconnection is associated with a said system protection terminal.

6. Distributed power generation system according to claim 1, further comprising at least one energy converter, whereby said at least one energy converter being associated with a said system protection terminal.

7. Distributed power generation system according to claim 6, wherein said system protection terminal associated with said at least one energy converter comprises means for altering supply of reactive power.

8. Distributed power generation system according to claim 6, wherein said system protection terminal associated with said at least one energy converter comprises means for altering tap changer operation.

9. Distributed power generation system according to claim 1, wherein said power sources are wind turbines.

10. System protection method for the protection of the integrity of an overall distributed power generation system, comprising the steps of:
generating electric power in at least two distributed power sources;
transferring said generated electric power over interconnections from said at least two distributed power sources to a point of connection to a power utility network;
collecting measurement signals associated with measured characteristics of said distributed power generation system in the vicinity of at least two of said at least two distributed power sources and in the vicinity of said point of connection;
communicating data associated with said measurement signals over a substantially dedicated communication resource;
processing, in the vicinity of at least two of said at least two distributed power sources and in the vicinity of said point of connection, said data for determining any need for system protection measures, and
providing control signals to units in said distributed power generation system, if system protection measures are necessary.

11. System protection method according to claim 10, wherein said characteristic of said electric power system comprises at least one of:
time stamped voltage values;
time stamped current values;
complex ac quantities, so called phasor quantities;
frequency; and
stability indicators.

12. System protection method according to claim 10, wherein said step of providing control signals comprises the step of providing control signals to operate at least one interconnection.

13. System protection method according to claim 10, wherein said step of providing control signals comprises the step of providing control signals to operate at least one energy converter.

14. System protection method according to claim 13, wherein said step of providing control signals to operate at least one energy converter comprises the step of altering supply of reactive power.

15. System protection method according to claim 13, wherein said step of providing control signals to operate at least one energy converter comprises the step of altering tap changer operation.

16 System protection arrangement for the protection of the integrity of an overall distributed power generation system, comprising:
electric generators in at least two distributed power sources;
interconnections from said at least two distributed power sources to a point of connection to a power utility network;
measurement means for collection of signals associated with measured characteristics of said distributed power generation system in the vicinity of at least two of said at least two distributed power sources and in the vicinity of said point of connection;
data processors arranged in the vicinity of at least two of said at least two distributed power sources and in the vicinity of said point of connection, said data processors being arranged for determining any need for system protection measures;
communication means having substantially dedicated communication resource for communication of data associated with said measurement signals between said measurement means and said data processors; and
control means connected to said data processors for providing control signals to units in said distributed power generation system, when said system protection measures are necessary.
